(19) United States
(12) Patent Application Publication
(10) Pub. No.: US 2018/0078078 A1
(43) Pub. Date: Mar. 22, 2018

(54) BEVERAGE FILTER ASSEMBLY

(71) Applicant: Haier US Appliance Solutions, Inc., Wilmington, DE (US)

(72) Inventors: Joseph Emil Gormley, Louisville, KY (US); Justin T. Brown, Louisville, KY (US)

(21) Appl. No.: 15/268,667

(22) Filed: Sep. 19, 2016

(51) Int. Cl. A47J 31/06; A47J 31/46; A47J 31/44

(52) U.S. Cl. CPC A47J 31/06; A47J 31/446; A47J 31/467

(57) ABSTRACT

A beverage slurry filter assembly is provided. The beverage slurry filter assembly may define a central axis and include a deflector plate, a separator fin, and a collection body. The deflector plate may extend across the central axis to receive a slurry liquid mixture. The deflector plate may include a perimeter defined about the central axis. The separator fin may be positioned along the perimeter of the deflector plate and define a plurality of apertures extending therethrough. The collection body may be positioned downstream from the separator fin to receive at least a portion of the slurry liquid mixture. The collection body may include a raised internal lip extending toward the deflector plate and defining a filtration passage along the central axis.

### FIELD OF THE INVENTION

The present subject matter relates generally to liquid filter assemblies, and more particularly to a filter assembly for a liquid beverage made from slurry mixture.

### BACKGROUND OF THE INVENTION

Methods currently exist for making certain beverages from a slurry mixture. For instance, methods exist for making coffee beverages without the use of heated or boiled water. These so-called “cold brewing” coffee-making methods can produce a coffee beverage that has a unique chemical and flavor profile when compared to conventional “hot brewed” coffee beverages. Moreover, cold-brewing methods often result in a beverage that has a lower acidity and caffeine content than conventional hot brewing methods.

Generally, cold brewing methods require non-heated, cold or lukewarm water to be added to a certain amount of particulate coffee or “grounds.” This combination blends to create a slurry mixture. As a slurry mixture, a portion of the particulate coffee may then dissolve into the water. Once a sufficient amount of coffee has dissolved, the remaining particulate may be filtered from the slurry mixture. After the particulate has been sufficiently filtered, the remaining fluid provides a liquid beverage.

Although cold brewing methods provide many advantages, they often require a greater amount of time than comparable hot brewing methods. For instance, when compared to hot brewing methods, particulate often takes a much greater time to dissolve in cold or room temperature water. Moreover, filtration can be excessively time-consuming with conventional cold brewing methods. Cold brewing methods often require a greater amount of particulate than hot brewing methods. Traditional filtration methods using, for example, only a single paper or mesh filter media, may require an undesirable amount of time to be effective. Moreover, they may be inadequate to fully remove particulate without significant user control or effort.

As a result, further improvements to beverage-making may be desirable. Specifically, improvements to filtration of beverage slurry mixtures may be advantageous in increasing beverage-making efficiency and efficacy. It may be particularly advantageous for a beverage filter assembly to address one or more of the above-described issues.

### BRIEF DESCRIPTION OF THE INVENTION

Aspects and advantages of the invention will be set forth in part in the following description, or may be obvious from the description, or may be learned through practice of the invention.

In one aspect of the present disclosure, a beverage slurry filter assembly is provided. The beverage slurry filter assembly may define a central axis and include a deflector plate, a separator fin, and a collection body. The deflector plate may extend across the central axis to receive a slurry liquid mixture. The deflector plate may include a perimeter defined about the central axis. The separator fin may be positioned along the perimeter of the deflector plate and define a plurality of apertures extending therethrough. The collection body may be positioned downstream from the separator fin to receive at least a portion of the slurry liquid mixture. The collection body may include a raised internal lip extending toward the deflector plate and defining a filtration passage along the central axis.

In another aspect of the present disclosure, a beverage slurry filter assembly is provided. The beverage slurry filter assembly may define a central axis and include an inlet conduit, a first separator element, a second separator element, and a filter media. The inlet conduit may extend along the central axis from a first end to a second end to direct a slurry liquid mixture therethrough. The first separator element may be mounted to the second end of the inlet conduit and include a deflector plate and separator fin. The deflector plate may extend across the central axis to receive the slurry liquid mixture. The separator fin may extend from the deflector plate toward an inner wall of the inlet conduit. The separator fin may define a plurality of apertures extending therethrough. The second separator element may be mounted to the inlet conduit downstream from the first separator element. The second separator may define a filtration passage along the central axis. The second separator may include a sloped wall disposed about the filtration passage along the central axis. The filter media may be positioned along the filtration passage.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a filter assembly according to an exemplary embodiment of the present disclosure.

FIG. 2 provides a cut-away perspective view of a portion of the exemplary filter assembly of FIG. 1.

FIG. 3 provides a side perspective view of the exemplary filter assembly of FIG. 1.

FIG. 4 provides a cut-away perspective view of the exemplary filter assembly of FIG. 3 along the line 4-4.

FIG. 5 provides a cut-away plan view of the exemplary filter assembly of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, in at least one embodiment, the present subject matter provides a filter assembly for separating particulate from a slurry liquid mixture that includes particulate and a liquid beverage. The filter assembly may include a deflector plate and a separator fin that are both positioned above a collection body. The slurry liquid mixture may flow toward the deflector plate before being directed through the separator fin to the collection body. The filter assembly will catch most particulate so that the liquid flowing out of the filter assembly is a liquid beverage that is substantially free of particulate and potentially ready for consumption.

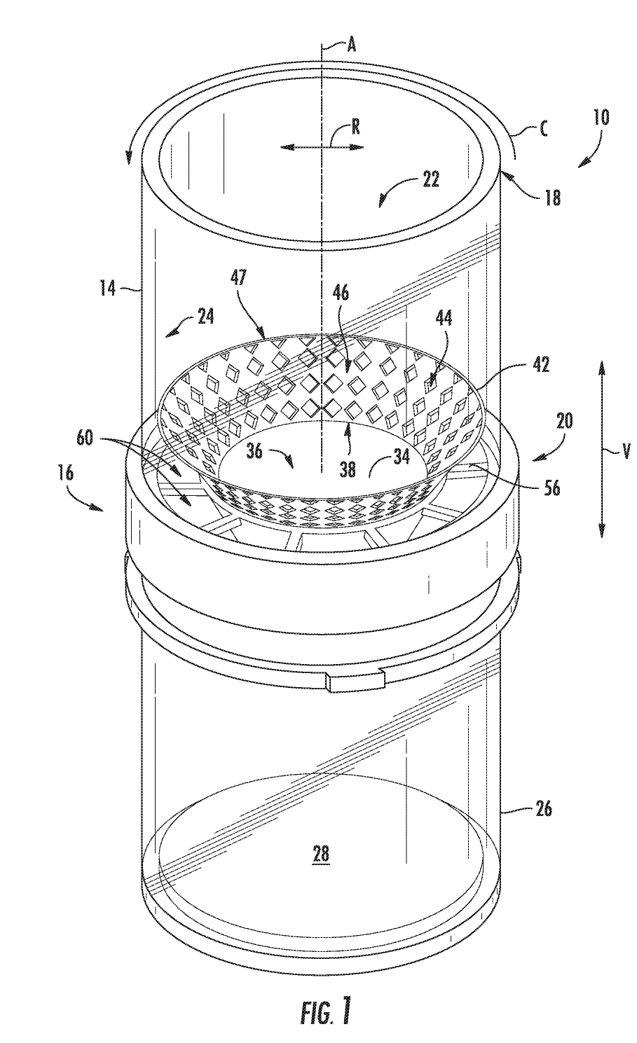

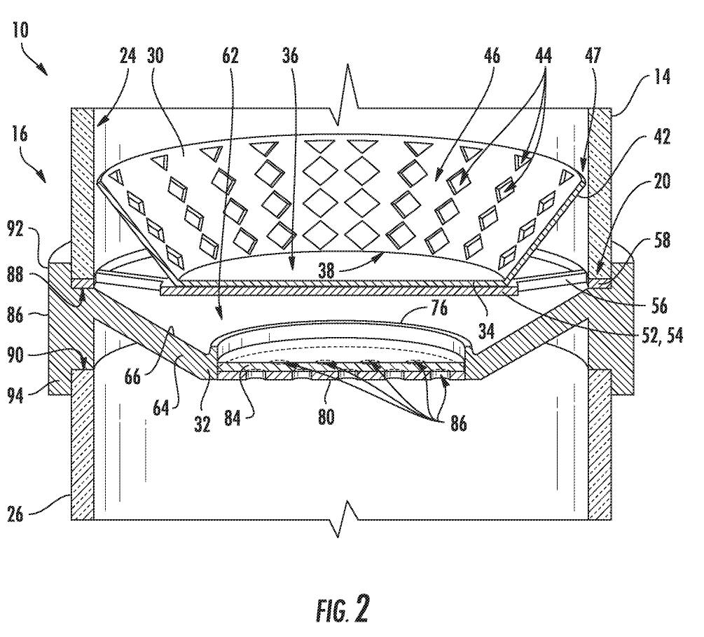

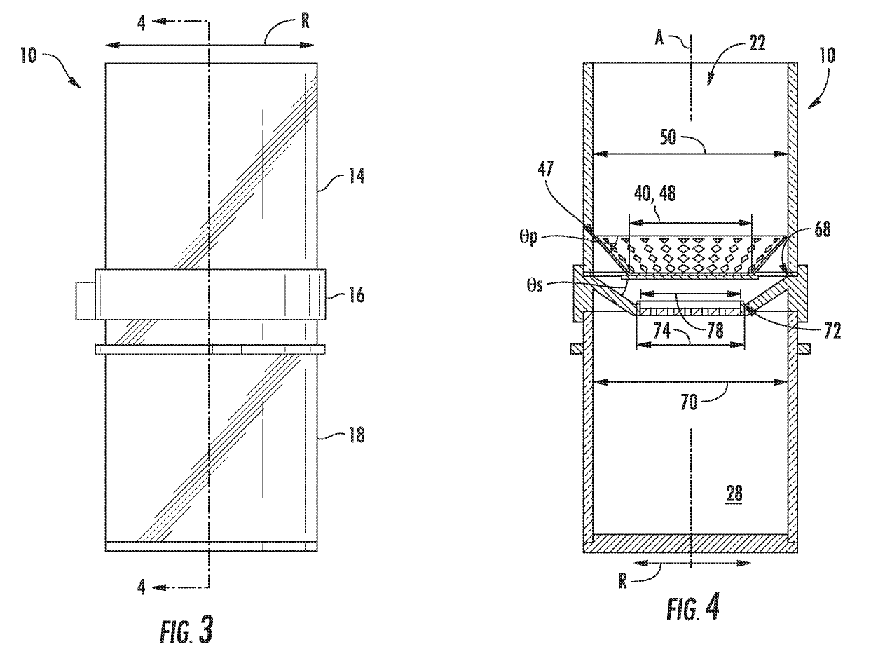

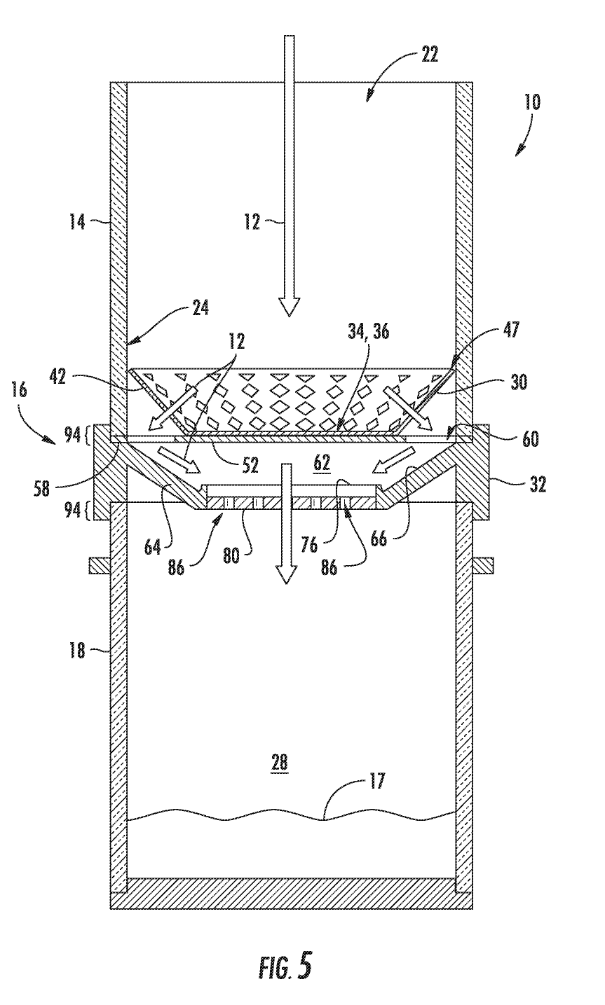

Turning now to the figures, FIGS. 1 through 5 provide an exemplary beverage slurry filter assembly 10 for separating particulate from a slurry liquid mixture (indicated by arrows at 12). Generally, filter assembly 10 defines a central axis A, a radial direction R, and a circumferential direction C. When assembled, central axis A may extend longitudinally, e.g., parallel to a vertical direction V. Radial direction R generally extends radially outward from the central axis A, as well as perpendicular thereto. Circumferential direction C is defined about the central axis A and may be defined in a plane parallel to radial direction R.

As shown, filter assembly 10 generally provides a separator assembly 16 positioned downstream from an inlet conduit 14 to receive a slurry liquid mixture 12 comprised of a particulate material (e.g., coffee or fruit pulp) mixed within a base liquid (e.g., water or fruit juice). Inlet conduit 14 extends along the central axis A between a first end 18 and a second end 20 to direct the slurry liquid mixture 12 therethrough. During use, inlet conduit 14 directs the slurry liquid mixture 12 through a flow passage 22 defined by an inner wall 24 of inlet conduit 14. Optionally, at least a portion of particulate material may be dissolved within the liquid to form a liquid beverage, such as a liquid coffee solution. As will be described in detail below, separator assembly 16 is operable to collect or remove the particulate material from the slurry liquid mixture 12. The remaining liquid 17 (i.e., the liquid remaining from the slurry liquid mixture after the particulate material has been removed) may be directed from the separator assembly 16 as a liquid beverage (e.g., a liquid coffee beverage or substantially pulp-free juice). As shown, a container, such as a beverage tank 26 defining a storage volume 28, may be provided. Specifically, beverage tank 26 may be provided below separator assembly 16 and/or inlet conduit 14 to receive the liquid beverage 17.

In some embodiments, separator assembly 16 includes multiple distinct elements 30, 32. For example, exemplary embodiments of separator assembly 16 include a first separator element 30 and a second separator element 32. As will be described in detail below, some such embodiments, first and second separator elements 30, 32 are mounted together at second end 20 of inlet conduit 14 to separate at least a portion of particulate material from the slurry liquid mixture 12. In optional embodiments, first and second separator elements 30, 32 are formed as an integral unitary structure.

As shown, first separator element 30 is mounted to inlet conduit 14 downstream from first end 18. First separator element 30 may be positioned below first end 18 (e.g., along the central axis A) to receive the slurry liquid mixture 12. In exemplary embodiments, first separator element 30 includes a deflector plate 34 that extends across the central axis A. Deflector plate 34 may include a planar surface 36 that faces flow passage 22. For instance, in certain embodiments, planar surface 36 is positioned perpendicular to central axis A in the radial direction R. Optionally, at least a portion of deflector plate 34, including planar surface 36, may be provided as a solid non-permeable member. For instance, deflector plate 34 may be formed from a non-permeable plastic or rubber material. Alternatively, deflector plate 34 may be formed from a dense mesh material (e.g., fine wire mesh) having a pore size smaller than the particulate grain size (i.e., the diameter of individual particulates of the slurry liquid mixture 12) to prevent the passage of particulate material through the deflector plate 34.

When assembled, deflector plate 34 generally defines a perimeter 38 about the central axis A. In some such embodiments, perimeter 38 may be defined along the radial extreme (e.g., maximum) of the deflector plate 34. A diameter (e.g., a first diameter 40) is defined across deflector plate 34 at the perimeter 38. In other words, diameter 40 may be defined at a radial extreme (e.g., maximum) of deflector plate 34. In some embodiments, perimeter 38 of deflector plate 34 is formed along a circular path, e.g., along the circumferential direction C. Deflector plate 34 may thus have a constant diameter 40, e.g., perpendicular to the central axis A. Optionally, deflector plate 34 may be aligned with the central axis A. Deflector plate 34 may furthermore be aligned coaxial with inlet conduit 14, e.g., at a radial extreme, such as a minimum, of inner. During use, at least a portion of the slurry liquid mixture 12 may be directed against deflector plate 34. A portion of particulate material may collect on deflector plate 34 while a remaining portion of the slurry liquid mixture 12 is directed away from deflector plate 34, e.g., towards another portion of first separator element 30.

In some embodiments, a separator fin 42 is provided to further separate particulate material from the slurry liquid mixture 12. As shown, separator fin 42 may be included with first separator element 30. Separator fin 42 generally defines a plurality of apertures 44 that extend through separator fin 42. The apertures 44 may be interspersed between a plurality of solid fin surfaces 46. Apertures 44 may be sized to substantially permit the slurry liquid mixture 12 therethrough. For instance, in exemplary embodiments, each aperture 44 may define an opening having a set shape or cross-sectional area through which the slurry liquid mixture 12 may pass. The cross-sectional area of each aperture 44 may be defined perpendicular to solid fin surfaces 46. Optionally, the cross-sectional area of each aperture 44 may be greater than 0.25 square inches, e.g., between 0.25 square inches and 4 square inches. In some embodiments, each of the plurality of apertures 44 includes an identical cross sectional area. In alternative embodiments, one or more of the plurality of apertures 44 include a cross-sectional area that is unique or different from some or all.

In some embodiments, separator fin 42 is positioned along perimeter 38 of deflector plate 34. Moreover, separator fin 42 may be attached to deflector plate 34 along perimeter 38. For instance, separator fin 42 may be integrally formed with deflector plate 34, e.g., as a single unitary structure. Additionally or alternatively, separator fin 42 may be joined to deflector plate 34 via an adhesive or mechanical fastener. In some embodiments, separator fin 42 extends from deflector plate 34 toward inner wall 24 of inlet conduit 14. In optional embodiments, separator fin 42 is mounted within inlet conduit 14. An outer fin edge 47 may extend along inner wall 24, e.g., in the circumferential direction C, in attached engagement with inner wall 24. In some such embodiments, outer fin edge 47 rests in contact with inner wall 24.

Separator fin 42 may extend at an angle (i.e., non-parallel) relative to the central axis A. For instance, separator fin 42 may extend upstream from deflector plate 34, opposite from the direction of the flow of slurry liquid mixture 12, at a predetermined plate angle θₚ. In some embodiments, the plate angle θₚ is between 25° and 50° relative to the central axis A. In certain embodiments, the plate angle θₚ is about 40°. As used herein, the term “about” is understood to mean within 3°.

Optionally, separator fin 42 may be formed as a frusto-conical member having two distinct parallel diameters, e.g., at the radial extremes of opposite ends. For instance, separator fin 42 may have an inner base diameter 48 at one radial extreme and an outer base diameter 50 at the opposite radial extreme. As shown, the outer base diameter 50 is greater than the inner base diameter 48. Each of inner base diameter 48 and outer base diameter 50 may be defined along the circumferential direction C. When assembled, inner base diameter 48 is positioned proximal to deflector plate 34 while outer base diameter 50 is positioned distal to deflector plate 34. In other words, inner base diameter 48 may be located closer to deflector plate 34, e.g., relative to the radial direction R and/or central axis A, than outer base diameter 50. Furthermore, inner base diameter 48 may be defined at deflector plate 34, e.g., along perimeter 38. Outer base diameter 50 may be defined at outer fin edge 47, e.g., along a radial extreme of inner wall 24.

During use, at least a portion of the slurry liquid mixture 12 may flow through separator fin 42. In some embodiments, such as the embodiments of FIGS. 1 through 5, slurry liquid mixture 12 that has been deflected by deflector plate 34 may flow through apertures 44 and/or against solid fin surfaces 46. Some portion of the particulate material may collect along separator fin 42, e.g., at the solid fin surfaces 46, while other portions of the particulate material may flow through apertures 44 with the slurry liquid mixture 12.

A support frame 52 is provided in some embodiments of separator assembly 16. For instance, support frame 52 may be included with first separator element 30. Generally, support frame 52 extends radially outward, e.g., along the radial direction R, from deflector plate 34. In some embodiments, support frame 52 includes a hub 54 positioned downstream from deflector plate. Hub 54 may be positioned below deflector plate 34, e.g., relative to the central axis A. Support frame 52 may be integrally formed with deflector plate 34, e.g., as a single unitary structure. Additionally or alternatively, hub 54 of support frame 52 may be joined to deflector plate 34 via an adhesive or mechanical fastener.

Support frame 52 may include or more spokes 56 that extend in the radial direction R, e.g., perpendicular to central axis A from hub 54. A radial passage 62 may be defined between each pair of adjacent spokes 56 to permit the flow of slurry liquid mixture 12. A frame rim 58 may be attached to each spoke 56, e.g., at a radial maximum of each spoke 56. In some such embodiments, frame rim 58 is extends along the circumferential direction C coaxial to deflector plate 34. Optionally, at least a portion of frame rim 58 is mounted below inlet conduit 14, e.g., relative to the central axis A. In some such embodiments, frame rim 58 is mounted such that frame rim 58 engages second end 20 of inlet conduit 14. Additionally or alternatively, frame rim 58 may be positioned above a portion of second separator element 32 e.g., relative to the central axis A. In some such embodiments, frame rim 58 is mounted such that frame rim 58 engages a portion of second separator element 32. Some embodiments of frame rim 58 are mounted between inlet conduit 14 and second separator element 32, thereby restricting support frame 52 movement relative to the central axis A. When assembled, support frame 52 may hold deflector plate 34 and/or separator fin 42 relative to the central axis A.

As shown in FIGS. 1 through 5, second separator element 32 is generally positioned downstream from first separator element 30. When assembled, second separator element 32 is mounted below first separator element 30 relative to the central axis A. A filtration passage 62 is defined by second separator element 32, e.g., along the central axis A. During use, a portion of slurry liquid mixture 12, e.g., the portion flowing through radial passages 62 from separator fin 42, may pass to second separator element 32 before a resulting liquid beverage 17 exits the filtration passage 62.

In some embodiments, second separator element 32 includes a collection body 64 to further separate particulate material from the slurry liquid mixture 12. As shown, collection body 64 may define filtration passage 62. In exemplary embodiments, a sloped wall 66 of collection body 64 defines at least a portion of filtration passage 62 along the central axis A. Sloped wall 66 may thus extend outward away from filtration passage 62. In some such embodiments, sloped wall 66 extends upstream from filtration passage 62, e.g., toward inlet conduit 14 from internal lip 76. Sloped wall 66 may extend at an angle (i.e., non-parallel) relative to the central axis A. For example, sloped wall 66 may extend upstream from filtration passage 62 at a predetermined wall surface angle θₛ. In some embodiments, the wall surface angle θₛ is between 40° and 70° relative to the central axis A. In certain embodiments, the wall surface angle θₛ is about 55°.

In optional embodiments, sloped wall 66 is formed as a frusto-conical member having a bottom wall edge 72 defining a bottom wall diameter 74 and an upper wall edge 68 defining an upper wall diameter 70, e.g., at a radial extreme of upper wall edge 68. As shown, the upper wall diameter 70 is greater than the bottom wall diameter 74. Each of upper wall diameter 70 and bottom wall diameter 74 may be defined along the radial direction R. When assembled, upper wall edge 68 may be positioned proximate to radial support frame 52 while bottom wall edge 72 is positioned distal to support frame 52. In other words, upper wall edge 68 may be located closer to support frame 52, e.g., relative to the radial direction R and/or central axis A, than bottom wall edge 72. As illustrated, bottom wall edge 72 may extend about the filtrations passage, e.g., in the circumferential direction C.

Exemplary embodiments of collection body 64 include a raised internal lip 76. For instance, raised internal lip 76 may extend from a portion of sloped wall 66, e.g., parallel to central axis A. When assembled, raised internal lip 76 may extend upstream, e.g., toward the deflector plate 34. Moreover, raised internal lip 76 may extend along the circumferential direction C, e.g., such that raised internal lip 76 is a substantially circular member. Optionally, raised internal lip 76 is coaxial with deflector plate 34.

In some embodiments, at least a portion of filtration passage 62 may be defined by raised internal lip 76. As shown, the portion of filtration passage 62 defined by raised internal lip 76 is thus positioned above the portion of filtration passage 62 otherwise defined by sloped wall 66, e.g., relative to central axis A. A diameter (e.g., a second diameter 78) is defined by raised internal lip 76, e.g., across filtration passage 62 in the radial direction R. Raised internal lip 76 may further define a diameter of filtration passage 62, e.g., such that the diameter of filtration passage 62 is equal to second diameter 78. Second diameter 78 may be defined as smaller than the first diameter 40 of reflector plate. Advantageously, slurry liquid mixture 12 from radial passage(s) 60 may be forced across sloped wall 66 and over raised internal lip 76. During use, some particulate material may accumulate along raised internal lip 76 radially outward from filtration passage 62 while surface tension causes additional particulate material to accumulate along sloped wall 66 above raised internal lip 76.

A perforated disc 80 may optionally be included adjacent to or within filtration passage 62. Perforated disc 80 may define one or more perforations 82 extending therethrough, e.g., parallel to central axis A. In embodiments such as those illustrated in FIGS. 1 through 5, perforated disc 80 extends across filtration passage 62. Perforated disc 80 may be positioned downstream from raised internal lip 76. Moreover, in some such embodiments, perforated disc 80 is positioned below raised internal lip 76 along the central axis A.

A filter media 84 may optionally be provided in some embodiments. In certain embodiments, filter media 84 is disposed over a portion of filtration passage 62. For instance, filter media 84 is positioned along or within filtration passage 62. Exemplary embodiments may include filter media 84 positioned on top of perforated disc 80. Filter media 84 may be shaped to complement filtration passage 62, e.g., a cylindrical disc having a diameter essentially equal to the diameter of filtration passage 62. Filter media 84 may include any suitable material for straining a desired liquid beverage 17 while restricting the movement of the particulate material therethrough. For instance, some filter media 84 embodiments include a fine metallic mesh or filtration paper. Some embodiments of filter media 84 may possess a pore size between 10 and 15 micrometers.

As illustrated, some embodiments of second separator element 32 include a mounting body 86 attached to collection body 64. Mounting body 86 may be positioned outward, e.g., relative to the radial direction R, from collection body 64 to support at least a portion of filter assembly 10. Mounting body 86 may define, for instance, a first circumferential shoulder 88 above filtration passage 62, e.g., relative to the central axis A. Mounting body 86 may further define a second circumferential shoulder 90 below filtration passage 62, e.g., relative to the central axis A. One or both of first and second circumferential shoulder 88, 90 may be defined as a flat support surface. Optionally, a first bounding ring 92 may extend above first circumferential shoulder 88, e.g., parallel to central axis A, at an outer radial location from first circumferential shoulder 88. Additionally or alternatively, a second bounding ring 94 may extend below second circumferential shoulder 90, e.g., parallel to central axis A, at an outer radial location from second circumferential shoulder 90.

When assembled, first circumferential shoulder 88 may be positioned in supportive engagement with first separator element 30 and/or inlet conduit 14. For instance, frame rim 58 of first separator element 30 may be positioned on first circumferential shoulder 88. First circumferential shoulder 88 may support frame 52 rim such that downward vertical motion thereof is restricted by mounting body 86. Additionally or alternatively, second end 20 of inlet conduit 14 may be positioned on circumferential shoulder, e.g., above frame rim 58 such that frame rim 58 is held between second end 20 and first circumferential shoulder 88. At least a portion of frame ring and/or inlet conduit 14 may be radially bound by first bounding ring 92, e.g., in radial engagement with first bounding ring 92. Second circumferential shoulder 90 may rest on beverage tank 26 such that beverage tank 26 in supportive engagement therewith. Beverage tank 26 may support mounting body 86 such that downward vertical motion of second circumferential shoulder 90 is restricted by beverage tank 26. At least a portion of beverage tank 26 may be radially bound by second bounding ring 94, e.g., in radial engagement with second bounding ring 94.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A beverage slurry filter assembly defining a central axis, the beverage slurry filter assembly comprising:
a deflector plate extending across the central axis to receive a slurry liquid mixture, the deflector plate including a perimeter defined about the central axis;
a separator fin positioned along the perimeter of the deflector plate, the separator fin defining a plurality of apertures extending therethrough; and
a collection body positioned downstream from the separator fin to receive at least a portion of the slurry liquid mixture, the collection body including a raised internal lip extending toward the deflector plate and defining a filtration passage along the central axis.

2. The beverage slurry filter assembly of claim 1, wherein the deflector plate defines a first diameter, wherein the raised internal lip is coaxial with the deflector plate and defines a second diameter, and wherein the first diameter is greater than the second diameter.

3. The beverage slurry filter assembly of claim 1, further comprising:
a beverage tank positioned in supportive engagement with the collection body, wherein the beverage tank is in fluid communication with the filtration passage.

4. The beverage slurry filter assembly of claim 1, further comprising:
a support frame extending radially from the deflector plate, wherein the support frame defines at least one radial passage in fluid communication between the separator fin and the filtration passage.

5. The beverage slurry filter assembly of claim 1, further comprising:
a perforated disc extending across the filtration passage.

6. The beverage slurry filter assembly of claim 5, wherein the perforated disc is positioned below the raised internal lip along the central axis.

7. The beverage slurry filter assembly of claim 1, wherein the deflector plate is positioned substantially perpendicular to the central axis.

8. The beverage slurry filter assembly of claim 1, wherein the separator fin extends upstream from the deflector plate at an angle between 25° and 50° relative to the central axis.

9. The beverage slurry filter assembly of claim 1, wherein the collection body includes a sloped wall extending upstream from the raised internal lip at an angle between 40° and 70° relative to the central axis.

10. The beverage slurry filter assembly of claim 1, further comprising:
an inlet conduit extending along the central axis in radial engagement with an outer edge of the separator fin.

11. A beverage slurry filter assembly defining a central axis, the beverage slurry filter assembly comprising:
an inlet conduit extending along the central axis from a first end to a second end to direct a slurry liquid mixture therethrough;
a first separator element mounted to the second end of the inlet conduit, the first separator element comprising
a deflector plate extending across the central axis to receive the slurry liquid mixture, and
a separator fin extending from the deflector plate toward an inner wall of the inlet conduit, the separator fin defining a plurality of apertures extending therethrough;
a second separator element mounted to the inlet conduit downstream from the first separator element, the second separator defining a filtration passage along the central axis, the second separator including a sloped wall disposed about the filtration passage along the central axis; and
a filter media positioned along the filtration passage.

12. The beverage slurry filter assembly of claim 11, wherein the second separator element defines a circumferential shoulder positioned in supportive engagement with the first separator element and the inlet conduit.

13. The beverage slurry filter assembly of claim 11, wherein the second separator element includes a raised internal lip extending toward the first separator element about the filtration passage.

14. The beverage slurry filter assembly of claim 13, wherein the deflector plate is coaxial with the inlet pipe and defines a first diameter, wherein the raised internal lip is coaxial with the deflector plate and defines a second diameter, and wherein the first diameter is greater than the second diameter.

15. The beverage slurry filter assembly of claim 13, wherein the second separator element includes a perforated disc extending across the filtration passage.

16. The beverage slurry filter assembly of claim 15, wherein the perforated disc is positioned below the raised internal lip along the central axis.

17. The beverage slurry filter assembly of claim 11, wherein the first separator element further includes a support frame extending radially outward from deflector plate, and wherein the support frame defines at least one radial passage in fluid communication between the separator fin and the second separator element.

18. The beverage slurry filter assembly of claim 11, wherein the deflector plate is positioned substantially perpendicular to the central axis.

19. The beverage slurry filter assembly of claim 11, wherein the separator fin extends upstream from the deflector plate at an angle between 25° and 50° relative to the central axis.

20. The beverage slurry filter assembly of claim 1, wherein the sloped wall extends upstream from the filtration passage at an angle between 40° and 70° relative to the central axis.
